(19) United States
(12) Patent Application Publication
(10) Pub. No.: US 2025/0074745 A1
(43) Pub. Date: Mar. 6, 2025

(54) SAFETY GEAR ARRANGEMENT FOR ELEVATOR, ELEVATOR, AND METHOD OF OPERATION OF SAFETY GEAR ARRANGEMENT FOR ELEVATOR

(71) Applicant: KONE CORPORATION, Helsinki (FI)

(72) Inventor: Tuukka KORHONEN, Helsinki (FI)

(73) Assignee: KONE CORPORATION, Helsinki (FI)

(21) Appl. No.: 18/939,392

(22) Filed: Nov. 6, 2024

Related U.S. Application Data
(63) Continuation of application No. PCT/FI2022/050450, filed on Jun. 22, 2022.

(51) Int. Cl. B66B 5/22; B66B 5/04

(52) U.S. Cl. CPC B66B 5/22; B66B 5/044

(57) ABSTRACT

A safety gear arrangement for an elevator includes a gripping mechanism having a gripping position and an inactive position, wherein the gripping mechanism is configured in the gripping position for gripping a rail for providing braking, an electric actuator, a coupling mechanism between the electric actuator and the gripping mechanism, wherein the coupling mechanism is adapted to arrange the gripping mechanism into the gripping position by the operation of the electric actuator, and an overspeed governor including at least an electrical energy source arranged to provide electrical power to the electric actuator at least in an over-speed situation of the elevator, wherein the gripping mechanism is arranged to the gripping position in response to determining, based on the operation of the overspeed governor, that there is the over-speed situation.

### FIELD OF THE INVENTION

The present invention relates to safety gear arrangements for an elevator, elevators including a safety gear, and methods of operation of elevator safety gear.

### BACKGROUND

Elevators have safety gears to stop the elevator car movement in case of an emergency, such as in an overspeed situation of the car. Typically, the overspeed governor and the safety gear are separate devices. In known solutions, the safety gear is activated by the mechanical overspeed governor which has a governor rope coupled to the safety gear and running via a governor sheave. In an overspeed situation, the governor sheave is stopped by a centrifugal stopping mechanism. This causes stopping of the governor rope, which further leads to activation of the safety gear such that the gripping mechanism of the safety gear is moved into a gripping position against guide rail of the car.

It is often the case that an elevator car has two such safety gears disposed on the opposite sides of the car. They are interconnected by a common synchronization axis which ensures that both safety gears will be activated upon operation of the centrifugal stopping mechanism of the overspeed governor. The synchronization axis together with the safety gears need space above or below the car to ensure proper operation.

In modern elevators, space-efficiency is an increasingly important factor. Therefore, there is a need for safety solutions that operate reliable even in a case of emergency but also save space.

### SUMMARY

An objective of the present invention is to provide a safety gear arrangement for an elevator, an elevator, and a method of operation of a safety gear arrangement of an elevator. Another objective of the present invention is that the safety gear arrangement, the elevator, and the method provide a reliable and space-efficient solution for provide braking even in a case of emergency of the elevator.

The objectives of the invention are reached a safety gear arrangement for an elevator, an elevator, and a method of operation of a safety gear arrangement of an elevator as defined by the respective independent claims.

According to a first aspect, a safety gear arrangement for an elevator is provided. The safety gear arrangement comprises a gripping mechanism having a gripping position and an inactive position, wherein the gripping mechanism is configured in the gripping position for gripping a rail for providing braking. In addition, the arrangement comprises an electric actuator, such as an electric motor, and a coupling mechanism between the electric actuator and the gripping mechanism, wherein the coupling mechanism is adapted to arrange the gripping mechanism into the gripping position by the operation of, such as force generated by, the electric actuator. Furthermore, the arrangement comprises an overspeed governor comprising at least an electrical energy source arranged to provide electrical power to the electric actuator at least in an overspeed situation of the elevator. The gripping mechanism is arranged to the gripping position in response to determining, based on the operation of the overspeed governor, that there is the overspeed situation.

In some embodiments, the overspeed governor may comprise a speed sensor for determining overspeed of an elevator car, wherein the electrical energy source comprises a battery.

Alternatively or in addition, the electrical energy source may comprise an electric generator for determining overspeed of an elevator car and arranged to be operated to generate electrical power, when the electrical energy source is moving relative to the rail. Furthermore, the electric generator may be arranged to be rotated by a driving element of the overspeed governor. In preferable embodiments, the driving element may be arranged to be in a non-contact electromagnetic interaction with the rail. Still further, the driving element may comprise permanent magnets for producing eddy current in the rail to cause the rotation of the driving element.

In various embodiments, the electric actuator may be a DC motor, such as a brushless DC motor.

Alternatively or in addition, the electrical energy source may be a DC generator, such as a brushless DC generator.

Still further, the DC generator may be coupled to the DC motor via a controllable power switch.

In various embodiments, the overspeed situation may be configured to be determined based on an output voltage of the electric generator.

The safety gear arrangement may comprise a position or proximity sensor for determining position of a safety gear wedge of the arrangement.

In some embodiments, the safety gear arrangement may comprise at least two gripping mechanisms, each of which are configured to be operated based on determining the overspeed situation by the overspeed governor.

In various embodiments, the coupling mechanism may be adapted to arrange the gripping mechanism into the gripping position by means of the force generated by the electric actuator to the gripping mechanism via the coupling mechanism, such as by a pulling or a pushing motion.

Furthermore, the gripping mechanism may be adapted to provide bidirectional braking.

In some embodiments, the coupling mechanism may comprise a rope, a wire, or a belt for transmitting the force generated by the electric actuator to the gripping mechanism.

In various embodiments, the coupling mechanism may comprise a counterweight for balancing mass of a safety gear wedge of the arrangement. The counterweight may be arranged to the rope, wire, or belt.

According to a second aspect, an elevator is provided. The elevator comprises an elevator car movable in an elevator shaft, at least one rail, such as a guide rail, extending along the elevator shaft, and the safety gear arrangement in accordance with the first aspect being coupled to the elevator car and arranged to provide braking in relation to the at least one rail.

According to a third aspect, a method of operation of a safety gear arrangement of an elevator is provided. The method comprises determining an overspeed situation based on operation of an overspeed governor, and providing electrical power generated by or stored in the overspeed governor to an electric actuator in response to the determining of the overspeed situation to move a gripping mechanism of the arrangement to a gripping position for providing braking in relation to a rail, such as a guide rail, wherein the electric actuator is mechanically coupled to a gripping mechanism of the safety gear by a coupling mechanism.

The present invention provides a safety gear arrangement, an elevator, and a method of operation of a safety gear arrangement of an elevator. The present invention provides advantages over known solutions in that the integrated overspeed governor and the safety gear save space while there is no need for external power supply because the safety gear arrangement is powered by the electrical energy source of the overspeed governor thereof.

Various other advantages will become clear to a skilled person based on the following detailed description.

The expression “a plurality of” may refer to any positive integer starting from two (2), that is, being at least two, two, three, four, etc.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the dependent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically a safety gear arrangement.

FIG. 2 illustrates schematically a safety gear arrangement.

FIG. 3 illustrates schematically a safety gear arrangement in connection with an elevator car.

FIG. 4 illustrates schematically an overspeed governor.

FIG. 5 illustrates schematically an elevator.

FIG. 6 shows a flow diagram of a method.

### DETAILED DESCRIPTION OF SOME EMBODIMENTS

In various embodiments, a safety gear arrangement, preferably comprising a bidirectional safety gear or gears, with an electrically controllable activation is provided. Bidirectional safety gear means that it has a gripping mechanism that acts in both movement directions, that is, in up and down directions of an elevator car.

Electrically controlled activation may mean that, for example, the safety gear arrangement is activated in response to a receiving an electrical activation signal. An electric actuator of the arrangement is then activated and may change the position of the gripping mechanism of the safety gear to provide braking, such as by a coupling mechanism therebetween for transmitting the force generated by the electric actuator to change the position of the gripping mechanism or mechanisms. For example, an overspeed governor detects the speed of the elevator car and supplies power to the safety gear on activation situation, such as due to an overspeed condition. Thus, safety gear wedge or roller movement is implemented based on an electrical activation, wherein the overspeed detection device, or the overspeed governor, is utilized to supply power to electric actuator generating the force to change the position to the gripping position. This is in contrast to traditional safety gears where the activation of the safety gear occurs in response to a tripping of an overspeed governor by centrifugal force during overspeed condition thereof, and then causes, via a mechanical coupling, the safety gear to activate.

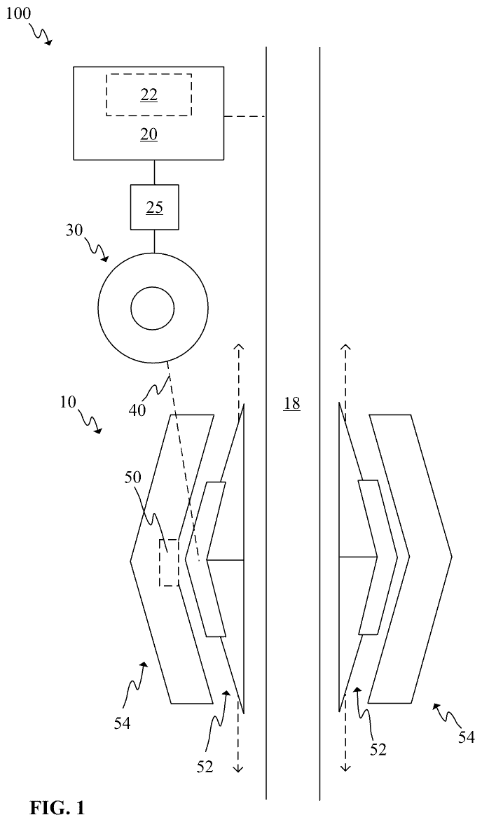

FIG. 1 illustrates schematically a safety gear arrangement 100 for an elevator, such as comprising one or several elevator cars movable in one or several elevator shafts to serve landing floors, for instance. The safety gear arrangement 100 comprises a gripping mechanism 10 having a gripping position and an inactive position, wherein the gripping mechanism 10 is configured in the gripping position for gripping a guide rail 18 for providing braking. In FIG. 1, the gripping mechanism 10 is shown in the inactive position. In the gripping position portion of the gripping mechanism 10 becomes in contact with the guide rail 18.

The safety arrangement 100 further comprises an electric actuator 30 and a coupling mechanism 40 between the electric actuator 30, such as an electric motor, and the gripping mechanism 10, wherein the coupling mechanism 40 is adapted to arrange the gripping mechanism 10 into the gripping position by the operation of the electric actuator 30. In various embodiments, the coupling mechanism 40 may mechanically transmit force generated by the electric actuator 30 to change the position of the gripping mechanism 10. The safety gear arrangement 100 also comprises an overspeed governor 20 comprising at least an electrical energy source 22 arranged to provide electrical power to the electric actuator 30 at least in an overspeed situation of the elevator. The gripping mechanism 10 is arranged to the gripping position in response to determining, based on the operation of the overspeed governor 20, such as a measurement thereof, that there is the overspeed situation.

Furthermore, an output of the overspeed governor 20, such as of the electrical energy source 22 thereof, may be connected to an input of the electric actuator 30 via a controllable power switch 25 or other such a switching arrangement. In various embodiments, the switch 25 may be used to selectively provide or interrupt electrical power to the electric actuator 30 so that braking can be provided whenever needed, such as in an overspeed situation, that is after or substantially simultaneously to the detection or determination thereof. The switch 25 may thus, in some embodiments, be connected to an elevator or safety controller (not shown) or relay (not shown) or the like which is configured to operate the switch 25.

In some embodiments, the overspeed governor 20 may comprise a speed sensor for determining overspeed of an elevator car, and the electrical energy source 22 may comprise a battery for storing and providing electrical power for operating the electric actuator 30. In case, the electrical energy source 22 comprises a battery, the arrangement 100 may also comprise a speed sensor for determining the speed of the elevator car, and thereby the overspeed situation can also be determined.

Alternatively or in addition, the electrical energy source 22 comprises an electric generator for determining overspeed of an elevator car and arranged to be operated to generate electrical power, when the safety gear is moving relative to the guide rail 18.

FIG. 1 further illustrates an optional position or proximity sensor 50 for determining position of a safety gear wedge 52 of the arrangement 100. The gripping mechanism 10 preferably also comprises a safety gear block 54 for guiding the wedge 52. The safety gear wedge 52 may thus provide braking when it gets wedged between the safety gear block 54 and the guide rail 18. The gripping mechanism 10 may be arranged to provide instantaneous or progressive braking. In some embodiments, the arrangement 100 may comprise a roller instead of a wedge 52. The wedge 52 or the roller may be arranged to move on a dedicated track between the gripping and inactive positions.

In various embodiments, and as is visible in FIG. 1 to a skilled person in the art, the safety gear arrangement 100 may comprise a bidirectional gripping mechanism 10, that is, it may be configured to provide braking selectively in either one of directions with respect to the longitudinal direction of the guide rail 18.

Regarding the position or proximity sensor 50, it can be used to identify the central position of the wedge 52, for instance. Furthermore, in some embodiments, it can alternatively or in addition, be used in the process of resetting the safety gear arrangement 100. In that case, the switch 25 may be arranged to be on as long as the wedge 52 is moving towards and reaches the central position.

The sensor 50 may also be utilized to check, such as periodically, the operation of safety gear arrangement 100 and components thereof. For example, the elevator car may be moved up and down with electrical connection between overspeed governor 20 and electric actuator 30. During said moving, the sensor 50 would change its state, such as on-off-on, if operating correctly. Thus, the correct operation may be determined and verified with the safety gear arrangement 100.

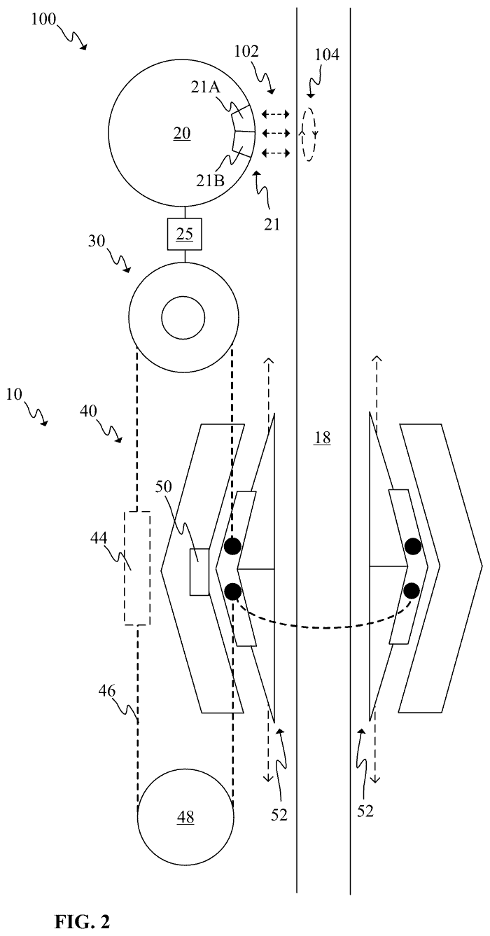

FIG. 2 illustrates schematically a safety gear arrangement 100. The arrangement 100 may comprise some similar or even identical features than shown in FIG. 1. However, in FIG. 2, the overspeed governor 20 is an electric generator. The overspeed governor 20 may in some embodiments a permanent magnet DC (direct current) generator.

Furthermore, the overspeed governor 20 may comprise a driving element 21 which is arranged to drive, such as rotate, the electric generator when the arrangement 100 moves relative to the guide rail 18. Thus, there is, preferably, a mechanical coupling between the driving element 21 and the electric generator. They may be essentially the same element or at least an integrated unit, however, there could also be a gear arrangement therebetween, for instance.

For example, the surface, or at least a region close to the surface, of the driving element 21 may have permanent magnets 21A, 21B arranged in a pole-wise alternating manner, that is, having their poles in north-south-north-south order or the like, for instance. The magnetic field of the driving element 21 thus preferably reaches the guide rail 18, which may preferably be of ferromagnetic material. The permanent magnets 21A, 21B thereby produce an alternating magnetic field when the arrangement 100 moves relative to the guide rail 18, which generates eddy currents 104 in the guide rail 18. This causes the rotation of the driving clement 21 due to the interaction 102 of the permanent magnets 21A, 21B and the magnetic field generated by the eddy currents 104. The driving element 21 thus rotates due to a touchless or contactless manner or interaction 102 with the guide rail 18. Alternatively, the driving element may be a friction wheel, thereby being in contact with the guide rail 18 and rotating due to the friction therebetween.

In some embodiments, the generator of the overspeed governor 20 may be a brushless permanent magnet DC generator with electrical commutation. In such generators, the magnitude of the DC voltage is in direct relation to the rotation speed, and the polarity of the voltage depends on the rotation direction. The DC generator may be coupled to the electric actuator via the controllable power switch 25. Therefore, the switch 25 between the generator and the electric actuator 30 can be turned on if a voltage having a first magnitude is reached, wherein the first magnitude relates to an overspeed situation. In other words, the voltage, that is the magnitude thereof, generated by the generator can be utilized to determine the speed, and thus compared to a threshold value for detecting an overspeed situation.

FIG. 2 further illustrates that the coupling mechanism 40 may comprise a rope 46, a wire, or a belt for transmitting force generated by the electric actuator 30 to the gripping mechanism. Still further, alternatively or in addition (as is the case in FIG. 2, the coupling mechanism 40 may comprises a counterweight 44 for balancing mass of a safety gear wedge 52 of the arrangement 100. Thus, the safety gear wedge 52 maintains its position more easily. As can be seen, the rope 46, wire, or belt may be arranged to extend around a safety gear sheave 48 in order to be able to move the wedge 52 selectively in different directions for, e.g., providing the bidirectional braking and/or moving the wedge 52 back to neutral position when being displaced therefrom for any reason, such as due to braking. Alternatively or in addition, a small magnet could be added keep the wedge(s) 52 and/or counterweight 44, if any, in place.

Furthermore, in various embodiments, the electric actuator 30 may be a DC motor, such as a brushless permanent magnet DC motor. The DC motor may be electrically connected to energy source 22, such as the DC generator or a battery (and optionally a power converter), of the overspeed governor 20, preferably, directly, or via an intermediate component/device, such as a power converter and/or a transformer.

The safety gear arrangement 100 may, thus, comprise wedges 52 or wedge brake pads, wedge guiding mechanism comprising safety gear block(s) 54, rope(s) 46, belt(s), the electric actuator 30, counterweight 44 and the position or proximity sensor 50.

In various embodiments, such as shown in FIGS. 1 and 2, the wedges 52 may be arranged on both sides of the guide rail 18, and they may be connected to each other. The connection may be such that the wedges 52 on both sides operate substantially simultaneously. This is marked in FIG. 2 by the arc between the wedges 52, however, there could be such a connection also in FIG. 1.

In addition, in various embodiments, the safety gear arrangement 100 may comprise at least two gripping mechanisms, each of which are configured to be operated based on determining the overspeed situation by the overspeed governor 20. Thus, a mechanical synchronization axis is not required between the safety gears since they can be operated electrically.

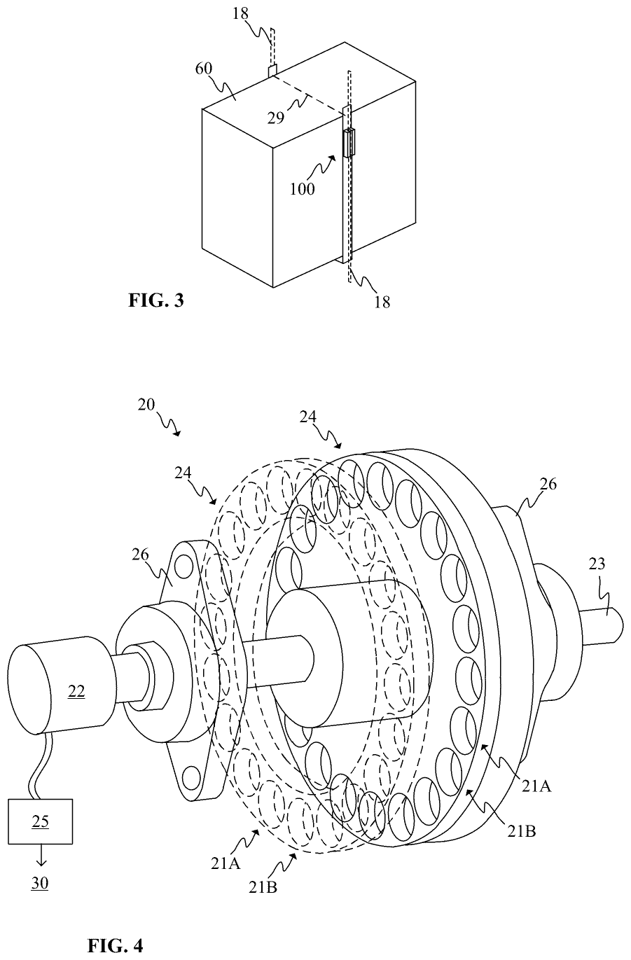

FIG. 3 illustrates schematically a safety gear arrangement 100 in connection with an elevator car 60. There can be only one safety gear and guide rail 18, or several safety gears and rails 18 arranged to the elevator car 60. In case of having a plurality of safety gears, that is at least electric actuators 30 and gripping mechanisms 10, they may be electrically connected to each other by an interconnection 29. Thus, in some embodiments, one overspeed governor 20 can be utilized to operate several electric actuators 30. As can be understood, there may alternatively be one overspeed governor 20 and one electric actuator 30 to operate several gripping mechanisms 10. Of course, the safety arrangement 100 may also be duplicated with respect to all of its components so that one elevator car 100 comprises several arrangements 100.

FIG. 4 illustrates schematically an overspeed governor 20. The overspeed governor 20 comprises an axis 23 to which there is arranged one or two rotors 24 having permanent magnets 21A, 21B. As described hereinbefore, the permanent magnets 21A, 21B may be arranged in a pole-wise alternating manner, that is, having their poles in north-south-north-south order or the like, for instance.

In FIG. 4, the permanent magnets 21A, 21B are arranged to holes at the peripheral portion of the rotor(s) 24. Furthermore, there may be the electrical energy source 22, such as a permanent magnet DC generator, arranged to rotate along the axis 29 or via a gear. In FIG. 4, the guide rail 18 is not shown, however, it would be arranged to adjacent to the permanent magnets 21A, 21B or between them in case of two rotors 24. The overspeed governor 20 may be attached to the elevator car 60 with support or fixing members 26, such being coupled to the axis 29 via bearings so as to enable rotation of the axis 29 relative to the support members 26. The support or fixing member 26 is used to fix the overspeed governor 20 to a support frame (not shown, however, could be adjacent to the fixing member(s) 26), which the support frame is further in connection with the elevator car 60.

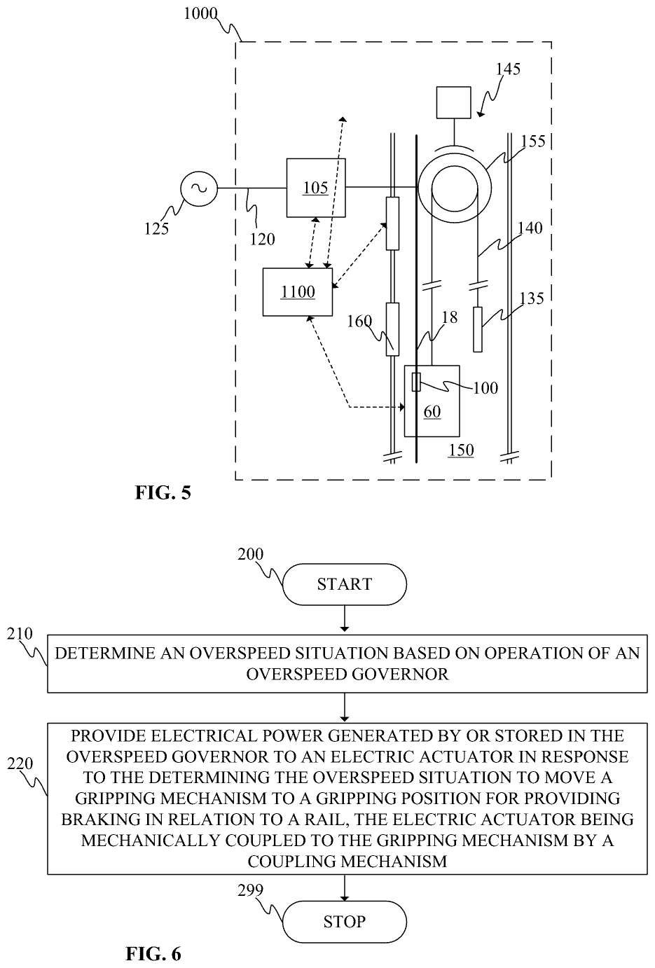

FIG. 5 illustrates schematically an elevator 1000. The elevator 1000 may comprise an electric motor 155 for moving an elevator car 60 in an elevator shaft 150 comprised in the elevator 1000. The elevator car 60 may be mechanically coupled to the electric motor 155, for example, by a hoisting rope 140, hydraulic means or in more direct manner in case of a linear motor. The operation of the electric motor 155 may, optionally, be controlled by an electrical drive 105 such as a frequency converter or an inverter. The motor 155 may be arranged to rotate an elevator sheave.

As can be seen, the elevator 1000 comprises the safety gear arrangement 100 as described hereinbefore. The safety gear arrangement 100 is coupled to the elevator car 60 and arranged to operate in connection with the guide rail 18 extending in the elevator shaft 150.

The hoisting rope 140 may comprise, for example, steel or carbon fibers. The hoisting rope 140 may in various embodiments be coupled to the elevator sheave, and may therefore be operated by the motor 155. The term ‘hoisting rope’ does not limit the form of the element anyhow. For example, the hoisting rope 140 may be implemented as a rope, a belt, or a track in ropeless or rope-free elevators.

The elevator 1000 may comprise an elevator control unit 1100 for controlling the operation of the elevator 1000. The elevator control unit 1100 may be a separate device or may be comprised in the other components of the elevator 1000 such as in or as a part of the electrical drive 105. The elevator control unit 1100 may also be implemented in a distributed manner so that, e.g., one portion of the elevator control unit 1100 may be comprised in the electrical drive 105 and another portion in the elevator car 60. The elevator control unit 1100 may also be arranged in distributed manner at more than two locations or in more than two devices.

The elevator 1000 may comprise an elevator brake arrangement 145 comprising an elevator brake, preferably, an electromechanical elevator brake, such as in connection with the motor 155 and/or the elevator sheave.

Other elements shown in FIG. 5, which may or may not be utilized in embodiments of the present invention, are a main electrical power supply 125 such as a three- or single-phase electrical power grid, an electrical connection 120 to the electrical drive 105, if any, and/or the electric motor 155. The elevator car 130 may operate in the shaft or hoistway 150 serving landing floors 160. There may or may not be a counterweight 135 utilized in embodiments of the present invention.

FIG. 6 shows a flow diagram of a method.

Item or method step 200 refers to a start-up phase of the method. Suitable equipment and components are obtained and systems assembled and configured for operation. This may mean arranging a safety gear arrangement 100 as described hereinbefore in connection with an elevator car 60 and a guide rail 18.

Item or method step 210 refers to determining an overspeed situation based on operation of an overspeed governor 20. This may be implemented, for example, by a speed sensor of the overspeed governor 20 or based on the operation of electrical energy source 22 of the governor 20, such as measured output voltage thereof, in case the electrical energy source 22 generates a voltage that is utilizable to indicate the speed.

Item or method step 220 refers to providing electrical power generated by or stored in the overspeed governor 20 to an electric actuator 30, such as a motor, in response to the determining of the overspeed situation to move a gripping mechanism 10 of the arrangement 100 to a gripping position for providing braking in relation to a rail 18, such as a guide rail, wherein the electric actuator 30 is mechanically coupled to the gripping mechanism by a coupling mechanism 40 of the arrangement 100.

Method execution may be stopped at step 299.

In some embodiments, in which the safety gear arrangement 100 comprises a position or proximity sensor 50 for determining position of a safety gear wedge 52 of the arrangement 1000, the method may further comprise moving the safety gear wedge 52 to a neutral position, such as to a central position, based on measurement by the position or proximity sensor 50 in cases where the safety gear wedge 52 has been displaced from the neutral position from one reason or another, such as after the provision of braking.

In some embodiments, the item or method step 220 may comprise providing electrical power generated by or stored in the overspeed governor 20 to multiple electric actuators 30 which are arranged to operate different safety gear wedges 52.

1. A safety gear arrangement for an elevator, the safety gear arrangement comprising:
a gripping mechanism having a gripping position and an inactive position, wherein the gripping mechanism is configured in the gripping position for gripping a rail for providing braking;
an electric actuator;
a coupling mechanism between the electric actuator and the gripping mechanism, wherein the coupling mechanism is adapted to arrange the gripping mechanism into the gripping position by the operation of the electric actuator; and
an overspeed governor comprising at least an electrical energy source arranged to provide electrical power to the electric actuator at least in an overspeed situation of the elevator,
wherein the gripping mechanism is arranged to the gripping position in response to determining, based on the operation of the overspeed governor, that there is the overspeed situation.

2. The safety gear arrangement of claim 1, wherein the overspeed governor comprises a speed sensor for determining overspeed of an elevator car, and wherein the electrical energy source comprises a battery.

3. The safety gear arrangement of claim 1, wherein the electrical energy source comprises an electric generator for determining overspeed of an elevator car and arranged to be operated to generate electrical power, when the electrical energy source is moving relative to the rail.

4. The safety gear arrangement of claim 3, wherein the electric generator is arranged to be rotated by a driving element of the overspeed governor.

5. The safety gear arrangement of claim 4, wherein the driving element is arranged to be in a non-contact electromagnetic interaction with the rail.

6. The safety gear arrangement of claim 5, wherein the driving element comprises permanent magnets for producing eddy currents in the rail to cause the rotation of the driving element.

7. The safety gear arrangement of claim 1, wherein the electric actuator is a DC motor.

8. The safety gear arrangement of claim 1, wherein the electrical energy source is a DC generator.

9. The safety gear arrangement of claim 7, wherein the electrical energy source is a DC generator, and wherein the DC generator is coupled to the DC motor via a controllable power switch.

10. The safety gear arrangement of claim 3, wherein the overspeed situation is configured to be determined based on an output voltage of the electric generator.

11. The safety gear arrangement of claim 1, further comprising a position or proximity sensor for determining a position of a safety gear wedge of the arrangement.

12. The safety gear arrangement of claim 1, further comprising at least two gripping mechanisms, each of the at least two gripping mechanisms being configured to be operated based on determining the overspeed situation by the overspeed governor.

13. The safety gear arrangement according to claim 1, wherein the coupling mechanism is adapted to arrange the gripping mechanism into the gripping position by means of the force generated by the electric actuator to the gripping mechanism via the coupling mechanism.

14. The safety gear arrangement of claim 1, wherein the gripping mechanism is adapted to provide bidirectional braking.

15. The safety gear arrangement of claim 1, wherein the coupling mechanism comprises a rope, a wire, or a belt for transmitting force generated by the electric actuator to the gripping mechanism.

16. The safety gear arrangement of claim 1, wherein the coupling mechanism comprises a counterweight for balancing mass of a safety gear wedge of the arrangement.

17. The safety gear arrangement of claim 15, wherein the counterweight is arranged to the rope, wire, or belt.

18. An elevator, comprising:
an elevator car movable in an elevator shaft;
at least one rail, extending along the elevator shaft; and
the safety gear arrangement of claim 1 coupled to the elevator car and arranged to provide braking in relation to the at least one rail.

19. A method of operation of a safety gear arrangement of an elevator, the method comprising the steps of:
determining an overspeed situation based on operation of an overspeed governor; and
providing electrical power generated by or stored in the overspeed governor to an electric actuator in response to the determining of the overspeed situation to move a gripping mechanism of the arrangement to a gripping position for providing braking in relation to a rail, wherein the electric actuator is mechanically coupled to the gripping mechanism of the arrangement by a coupling mechanism of the arrangement.

20. The safety gear arrangement of claim 2, wherein the electric actuator is a DC motor.
